(19) United States
(12) Patent Application Publication
(10) Pub. No.: US 2009/0286919 A1
(43) Pub. Date: Nov. 19, 2009

(54) REACTION ADHESIVE

(75) Inventors: Thomas Möller, Düsseldorf (DE); Guido Kollbach, Apex, NC (US); Pavel Gentschev, Düsseldorf (DE); Claudia Meckel-Jonas, Shanghai (CN)

Correspondence Address: Henkel Corporation, 10 Finderne Avenue, Bridgewater, NJ, 08807, US

(73) Assignee: Henkel AG & Co. KGaA, Dusseldorf (DE)

(21) Appl. No.: 12/469,161

(22) Filed: May 20, 2009

Related U.S. Application Data
(63) Continuation of application No. PCT/EP2007/005982, filed on Sep. 18, 2007.

(30) Foreign Application Priority Data
Nov. 24, 2006 (DE) 102006055974.6

(51) Int. Cl. C08L 33/08

(52) U.S. Cl. 524/523

(57) ABSTRACT

A two-component bonding agent system, comprising (a) a polymer with at least two Michael acceptor groups with an average molecular weight of from 1,000 g/mol to 1,000,000 g/mol, (b) a polymer or oligomer with at least two primary or secondary amino groups or blocked amino groups, and (c) optionally, additive, auxiliary and/or catalyst, is described.

The adhesive made from the two-component bonding agent systems is useful for composite films, particularly suited for packaging foodstuffs and luxury foods and medicinal products.

### CROSS REFERENCE TO RELATED APPLICATIONS

This application is a continuation of PCT/EP2007/059828 filed Sep. 18, 2007, which claims the benefit of DE 10 2006 055 974.6, filed Nov. 24, 2006, the complete disclosures of which are hereby incorporated by reference in their entirety.

### FIELD OF INVENTION

The invention relates to crosslinkable two-component bonding agent systems based on polymers having Michael acceptor groups and polymers having amino groups. Such 2-K bonding agent systems can be employed for manufacturing adhesives, sealing compounds or casting resins.

### BACKGROUND

Two-component bonding agent systems, particularly based on polyols and NCO-terminated compounds, have long been known in the prior art. They are employed, for example in the metal working industry, the automobile industry, the electrical industry, the packaging industry or the building industry as adhesives, sealants, fillers or castings.

A disadvantage of the polyurethanes with NCO groups used as “curing agents” is the moisture sensitivity. Consequently, suitably sealed packaging has to be used for storing these compounds. Generally, the polyol components have to be carefully dried prior to mixing with the curing agents, because otherwise, any residual moisture can lead to the formation of unwanted bubbles in the adhesive film, which under certain circumstances can be disadvantageous for the final application. A further disadvantage for at least some bonding agent systems based on two-component polyurethane adhesives, is the toxicology of monomeric isocyanates, in particular highly volatile and/or easily migratable monomeric diisocyanates, in the curing components. Such uses require the user to implement costly protective measures in the workplace, in particular to maintain clean and breathable air, the maximum legally permitted concentration of handled materials as gas, vapor or particulate matter in the air at the workplace being specified.

However, free monomeric polyisocyanates can also migrate into the coating or adhesive bond, or even partially into the coated or glued materials. Such migrating ingredients are commonly called “migrates” by technical specialists. On contact with moisture, the isocyanate groups of the migrates are continuously reacted to amino groups. Migrates are highly undesirable in the packaging industry and particularly in the packaging of foods. On the one hand, the passage of the migrates through the packaging material can lead to contamination of the packaged product; on the other hand, long waiting times are necessary before the packaging material is “migrate-free” and can be used.

Another unwanted effect, which can be caused by the migration of monomeric diisocyanates, is the so-called anti-sealing effect in the production of bags or carrier bags from laminated plastic films. The laminated plastic films often contain slip agents based on fatty acid amides. The reaction of migrated monomeric polyisocyanate with the fatty acid amide and moisture forms urea compounds with a melting point above the sealing temperature of the plastic films on the surface of the film. This leads to the formation between the films to be sealed of a “foreign” layer, which hinders the formation of a homogeneous sealing seam.

EP 1 462 501 describes Michael crosslinking mixtures, which consist of a multifunctional Michael donor and at least one multifunctional Michael acceptor. Compounds that carry acetoacetoxy functional groups are described as Michael donors. A method for gluing substrates is described in EP 1 435 383, wherein a mixture of a multifunctional Michael donor and a multifunctional Michael acceptor is described as an adhesive, wherein a strongly basic catalyst has to be comprised. The usual Michael-reactive functional groups that possess CH-acidic groups activated by neighboring CO or CN groups are described as the Michael donors. Compounds that can remove an H atom from the Michael donor are described as the strongly basic catalysts, wherein amine compounds, ammonium compounds, hydroxides or alkoxides are enumerated. Tertiary amines are listed in particular, such as DBU or DBE.

The disadvantages of the above-mentioned Michael crosslinking systems are that very strong catalysts have often to be employed. In certain cases this can provoke damage to the substrate. Furthermore, appropriate working conditions and security measures are required when processing strongly basic materials.

### SUMMARY OF THE INVENTION

The object of the present invention was to provide a bonding agent system that exhibits at least as good product properties as a two-component bonding agent system based on compounds containing isocyanate groups, and polyols, but without having the disadvantages of that type of system. In particular, the systems should exhibit good adhesion/sealing properties.

According to the invention, the object is achieved by referring to the claims.

It consists essentially in a bonding agent system consisting of the components A and B, in which
A) comprises at least one polymer that possesses at least two Michael acceptor groups,
B) comprises at least one polymer or oligomer that possesses at least two primary or secondary amino groups or blocked amino groups, and
optional additives, auxiliaries and/or catalysts, wherein the component A has a molecular weight (Mₙ) between 500 g/mol and 1,000,000 g/mol and component B possesses two terminal amino groups.

### DETAILED DESCRIPTION OF THE INVENTION

The upper limit of the molecular weight (Mₙ) of component A can also in particular cases be up to 10,000,000 g/mol; preferably component A has an average molecular weight (Mₙ) of 1500 g/mol to 100,000 g/mol, particularly preferably from 2000 g/mol to 50,000 g/mol. The molecular weights refer, unless otherwise stipulated, to number average molecular weights (Mₙ) as determined by gel permeation chromatography (GPC).

Any polymer can be used as the compound with at least two Michael acceptor groups, in so far as the criterion of molecular weight is respected and that they do not have any other functional groups that could interfere with the reaction with the component (B). The compound carrying at least two Michael acceptor groups can be either linear or also branched.

Functional groups that act as Michael acceptors are understood to mean those that possess unsaturated double bonds and at least one electron-withdrawing substituent in the α-position. They can be for example α,β-unsaturated carboxylic acid derivatives with 2 to 12 carbon atoms, preferably 2 to 6 carbon atoms which can have a linear or branched aliphatic, cycloaliphatic or aromatic structure. In particular they are α,β-unsaturated carbonyl compounds such as α,β-unsaturated aldehydes or ketones, acrylic acid derivatives, methacrylic acid derivatives, crotonic acid derivatives, itaconic acid derivatives, maleic acid derivatives, fumaric acid derivatives, citraconic acid derivatives, cinnamic acid derivatives, α-sulfonic- or phosphonic-substituted unsaturated compounds, such as vinylsulfonic derivatives, vinylphosphonic derivatives or nitro-styrene derivatives.

According to the invention there must be at least two Michael acceptor groups present in the polymer. However, there can be up to ten, especially up to five Michael acceptor groups, reacted into the polymer structure. They can be different functional Michael acceptor groups, but preferably they are the same functional groups. The equivalent weight based on this group should generally be between 100 and 30,000 g/mol, especially between 200 and 20,000 g/mol.

The provision of α,β-unsaturated carbonyl groups to the polymer, hereinafter called functionalization, can be effected during the synthesis of the polymer chain, wherein suitable monomers that contain activated unsaturated double bonds are employed. However, it is preferred to subsequently functionalize an already prepared base polymer. For this, the addition of hydroxyalkyl substituted unsaturated carboxylic acid esters to base polymers carrying anhydride groups or isocyanate groups is particularly preferred. For subsequently functionalizing the base polymer, hydroxy-substituted alkyl esters of α,β-unsaturated carboxylic acids, hydroxy-substituted alkyl amides of unsaturated carboxylic acids, for example can be transesterified with carboxylic groups or ester groups of the base polymer. Polymers are then obtained that comprise activated unsaturated double bonds in the side chains.

A further possibility for the functionalization concerns alkylidenemalonic esters that can be incorporated into the polymer chain by transesterification or that can be prepared by the Knoevenagel reaction of polymers, preferably polyesters, with carboxyl derivatives such as aldehydes and ketones; Knoevenagel reaction products with aldehydes are preferred.

The Michael acceptor groups of component A are preferably located at the ends of the polymer chains, however in some cases, compounds may also be used as component A, which comprise these groups statistically distributed over the whole polymer chain.

Component A is preferably a polymer carrying a Michael acceptor group, wherein the base polymer is selected from the group of fat chemical compounds, polyethers, polyether polyols, polyesters, polyester polyols, polycarbonates, polycarboxylic acids, polyacrylates, polymethacrylates, polyamides, polyurethanes or mixtures thereof. The fat chemical compounds are preferably castor oil or dimer diol, which have been alkoxylated. Polyamides used as the component A are understood to be those that do not have amine NH groups. Base polymers of this type are known per se and can be selected according to their inherent properties.

By choosing the component A and by the choice of the functionalization with the unsaturated carbonyl derivatives, it is possible to obtain polymers that comprise urethane groups or only ester groups. The viscosity of the polymer can be influenced in this manner. In a further embodiment, a further low molecular weight component (A1), exhibiting a plurality of α,β-unsaturated carbonyl groups, can be comprised in the bonding agent system in addition to higher molecular weight polymers. This component should have a molecular weight <1000 g/mol, preferably <800 g/mol, and comprise at least two α,β-unsaturated carbonyl groups. For example, they can concern di- to pentahydric alcohols that were reacted to ester groups with the above-mentioned α,β-unsaturated carboxylic acids. Components of this type are also called reactive diluents and can be added, for example, in amounts of up to 50 wt. %, preferably up to 25 wt. %, based on the amount of component A.

The inventive bonding agent system comprises as the component B at least one compound with at least two —NHR atom groupings, or a mixture of such compounds, with R═H, an alkyl group or aryl group or a compound with at least one —NH₂ group. This component B exhibits as the component B1 an average molecular weight (Mₙ) of 60 g/mol to 500 g/mol, preferably 60 g/mol to 300 g/mol or as the component B2 an average molecular weight (Mₙ) of >500 g/mol, wherein component B is present as either component B1 or B2 or as a mixture of B1 with B2. The weight ratio of (B1) to (B2) in the added mixture of (B1) with (B2) is 0.5:20 to 20:0.5.

The upper limit of the molecular weight (Mₙ) of component B2 is ca. 5,000,000 g/mol. Preferably, component B2 has an average molecular weight (Mₙ) of 800 g/mol to 2,000,000 g/mol, particularly preferably from 1000 g/mol to 1,500,000 g/mol. The inventively added component B1 is added as a sole component or preferably as a mixture of the suitable compounds that can be employed as the component B1.

The inventively employable component B can be either linear or branched. The molecular backbone of component B can comprise aliphatic, aromatic, aliphatic-aromatic, cycloaliphatic and heterocyclic structures. Primary and/or secondary and tertiary amines can be present in the molecule, however at least two —NHR atom groupings or one NH₂ group, preferably two primary amino groups must be included. The amine functions themselves are aliphatic, i.e. the carbon atoms directly neighboring the amine nitrogen are not part of an aromatic ring structure.

Component B1 is preferably selected from the group of the alkylenediamines and/or cycloalkylenediamines. Alkylene diamines are understood to mean compounds of the general formula R⁴R⁵N-Z-NR⁶R⁷, in which R⁴, R⁵, R⁶, R⁷ independently of one another can be H, alkyl or cycloalkyl groups. Z means a linear or branched, saturated or unsaturated alkylene chain containing >2 carbon atoms. Preferred examples are diaminoethane, diaminopropane, 1,2-diamino-2-methylpropane, 1,3-diamino-2,2-dimethylpropane, diaminobutane, diaminopentane, 1,5-diamino-2-methylpentane, neopentyldiamine, diaminohexane, 1,6-diamino-2,2,4-trimethylhexane, 1,6-diamino-2,4,4-trimethylhexane, diaminoheptane, diaminooctane, diaminononane, diaminodecane, diaminoundecane, diaminododecane, dimer amine (commercially available, for example under the trade name Versamin 551 from Cognis), triacetone diamine, dioxadecanediamine, N,N-bis(3-aminopropyl)-dodecylamine or mixtures thereof.

Cycloalkylenediamines are understood to mean compounds of the general formula R⁸R⁹N—Y—NR¹⁰R¹¹, in which R⁸, R⁹, R¹⁰, R¹¹ independently of one another can be H, alkyl or cycloalkyl groups. Y means a saturated or unsaturated cycloalkyl group containing >3 carbon atoms, preferably >4 carbon atoms. Diaminocyclopentanes, diaminocyclohexanes, diaminocycloheptanes, for example 1,4-cyclohexanediamine, 4,4′-methylene-bis-cyclohexylamine, 4,4′-isopropylene-bis-cyclohexylamine, isophoronediamine, m-xylylenediamine, N-aminoethylpiperazine or mixtures thereof are preferred.

The diamines can also comprise both alkyl as well as cycloalkyl groups together. Preferred examples are aminoethylpiperazine, 1,8-diamino-p-menthane, isophoronediamine, 1,2-(bisaminomethyl)-cyclohexane, 1,3-(bisaminomethyl)-cyclohexane, 1,4-(bisaminomethyl)-cyclohexane, bis-(4-aminocyclohexyl)-methane. Further examples of inventively employable diamines as the component B1 are bis-(6-aminohexyl)-amine, α,α-diaminoxylenes, etc.

Preferably, polyfunctional amines are employed as the component B1 and/or component B2. In particular, these are amino functionalized polyalkylene glycols, such as 1,2-bis-(aminoethoxy)-ethane, 1,13-diamino-4,7,10-trioxatridecane. Preferred inventively employable amine functionalized polyalkylene glycols are commercially available. Similarly preferred polyfunctional amines that can be employed as the component B1 and/or component B2 are compounds of the general formula H₂N—(CH₂CH₂—NH)ₓ—CH₂CH₂—NH₂, with 2<x<10, such as e.g. diethylenetriamine, triethylenetetramine, tetraethylenepentamine, pentaethylenehexamine, dipropylenetriamine, bis-(3-aminopropyl)-amine, N,N-bis-(3-aminopropyl)-ethylenediamine, bis-hexamethylenetriamine, heptaethyleneoctamine and the like.

Preferably, polymers are employed as the component B2, which are selected from the group of the polyamines, polyimines, polyethers, polyamides, polyamino amides, polyurethanes, polyolefins, polyvinylamines or mixtures thereof.

Polyamines that can be used as the component B2 are described by Henry Lee and Kris Neville, Handbook of Epoxy Resins, chapter 7, pages 7-1 to 7-33, McGraw-Hill Book Company, New York 1967 and references cited therein, as well as by Clayton A. May, Epoxy Resins, pages 466-468, Marcel Dekker, New York 1988 and references cited therein.

Preferred polyimines are polyethylenimine. The amine hydrogen functions of polyethylenimine can also be partially modified, for example by alkylation, benzylation, acetylation, alkoxylation, preferably ethoxylation and/or propoxylation. Modification with epichlorohydrin is particularly preferred. Preferred employable polyethylenimines are commercially available.

Polyamino amides comprise both amine and amido functionalities in the main chain. Polyamino amides are manufactured by polycondensation of polyamines and dicarboxylic acids or by the Michael addition of acrylic acid esters to diamines and the subsequent polycondensation of the resulting amino acid esters. Polyamino amides that can be used as the component B2 are described by Henry Lee and Kris Neville, Handbook of Epoxy Resins, chapter 10, pages 10-1 to 10-23, McGraw-Hill Book Company, New York 1967, as well as by Clayton A. May, Epoxy Resins, page 469, Marcel Dekker, New York 1988 and references cited therein.

In the context of the present invention, preferred polyamino amides are used that are obtained by polycondensation of aliphatic polyamines and dimerized or trimerized fatty acids. The non-grafted and grafted polyamino amides, such as those described in WO 94/29422, can also be employed.

Further preferred polyamines that can be used as the component B2 are polyvinylamines. Polyvinylamines can be manufactured, for example by polymerizing N-vinyl acylamines, such as N-vinyl formamide, N-vinyl acetamide, etc. and the subsequent complete or partial hydrolysis of the amide group. Amine-terminated polyether urethanes are likewise available.

Further polyamines that can be employed as the component B2 are the highly branched polymers that carry amino groups on the ends of the branches, particularly primary amino groups. A particularly preferred group of highly branched polymers used as the component B2 are the dendritic polymers that are also known as dendrimers, cascade polymers or starburst polymers. These are understood to be synthetic macromolecules that are constructed stepwise by linking 2 or more monomers with each of the already bound monomers, with the result that the number of monomeric end groups increases exponentially with each step and finally results in a spherical tree structure. Preferred dendrimers are polyamino amides (PAMAM) having primary amino functions on the ends of the branches.

A further preferred group of highly branched polymers that can be employed as the component B2 results, for example, from the step reaction of acrylic acid esters with suitable representatives of the abovementioned polyfunctional amines of the general formula H₂N—(CH₂CH₂—NH)X—CH₂CH₂—NH₂ with 2<x<10, such as e.g. diethylenetriamine, triethylenetetramine, tetraethylenepentamine, pentaethylenehexamine.

The inventively employable component (B2) can also be manufactured by the reaction of an excess of the low molecular weight polyfunctional amines, mentioned above as being usable as component (B1), with cyclic carbonates, which have an average molecular weight (Mₙ ) of less than 1000 g/mol, preferably 100 g/mol to 800 g/mol. In these cases, a suitable molar excess of amine in relation to cyclocarbonate has to be chosen, such that firstly the inventive molecular weight is attained and secondly the inventive amine functionality for the use as component B2 is present.

The inventively added component B2 is added as the sole component or also as a mixture of the suitable compounds that can be employed as the component B2.

Compounds that have at least one primary amino group can also be optionally comprised as B3. These can likewise react with two activated double bonds. Various organic groups can be selected as the substituent R on the amino group, for example alkyl, aryl substituents, linear, branched, cyclic or heterocyclic substituents, substituents based on polyethers, polyesters, polyacrylates, polyurethanes or polyolefins. The molecular weight of B3 should preferably be between 50 and 5000 g/mol, especially between 100 and 2000 g/mol.

In a particular embodiment, a component B4 that has blocked primary or secondary amino groups can also be employed. In this case it can concern the above-mentioned polyamines that have been treated with protection agents on the amino functions. Blocking can be carried out for example by ketimine groups, oxazolidine groups or azetidine groups. Such blocked amines are commercially available under for example the trade names Desmophen (Bayer) or described for example in DE 10356489.

The blocking agents are cleaved by moisture. The resulting primary or secondary amino groups can then react with the reactive Michael acceptor groups of the component A.

The inventive bonding agent system is particularly suitable as an adhesive/sealant.

Accordingly, a subject matter of the present invention is also a process for the manufacture of an adhesive/sealant using the inventive bonding agent system, wherein component A is mixed with component B in the ratio of the α,β-unsaturated activated double bonds to primary amine groups of 3:1 to 1:5, preferably 2.5:1 to 1:4, particularly preferably 2:1 to 1:2.5 and particularly 1.5:1 to 1:1.5. Here, each of the functional groups of the components A, A1 as well as B1, B2, B3, B4 together are to be taken into account.
In a preferred embodiment of the inventive process, the reaction between component A and component B takes place in the presence of a solvent.

Basically, all solvents known to the person skilled in the art can be used as the solvent, particularly esters, ketones, halogenated hydrocarbons, alkanes, alkenes and aromatic hydrocarbons. Exemplary solvents are methylene chloride, trichloroethylene, toluene, xylene, butyl acetate, amyl acetate, isobutyl acetate, methyl isobutyl ketone, methoxybutyl acetate, cyclohexane, cyclohexanone, dichlorobenzene, diethyl ketone, di-isobutyl ketone, dioxane, ethyl acetate, ethylene glycol monobutyl ether acetate, ethylene glycol monoethyl acetate, 2-ethylhexyl acetate, glycol diacetate, heptane, hexane, isobutyl acetate, isooctane, isopropyl acetate, methyl ethyl ketone, tetrahydrofuran or tetrachloroethylene or mixtures of two or more of the cited solvents. Halogen-free solvents are preferred.

In a particular embodiment of the inventive process, the reaction between component A and component B takes place in the presence of a catalyst. For this, catalytic quantities of a base are added to the mixture. These types of bases and the amounts to be added are described in Houben-Weyl, vol. XI/1, (1957), page 277 ff. and Patai, “The Chemistry of the Amino Group, pp 61-65, Interscience, New York (1968). According to the invention, a compound that catalyzes the Michael reaction must be present in the component B. This consists of catalysts in the form of Lewis bases or Brönstedt bases, wherein the conjugated acids of the latter have a pK_{A} of at least 10. In particular, they are amine-containing or amine-free bases. Exemplary amine-free bases are hydroxides or alcoholates of alkali metals such as LiOH, NaOH, KOH, NaH, KH, CaH₂, Na methoxide, Na ethoxide, K methoxide, K tert.-butoxide, potassium carbonate, calcium carbonate or similar compounds.

Lewis bases have proved to be particularly suitable, such as e.g. those of the group of cycloaliphatic amines, such as diazabicyclooctane (DABCO), tert.-aliphatic amines such as triethylamine, tripropylamine, tributylamine, N-methyldiethanolamine, N-methyldiisopropylamine or N-butyldiethanolamine, as well as amidines such as diazabicyclononene (DBN), diazabicycloundecene (DBU), and guanidines, such as e.g. N,N,N′,N′-tetramethylguanidine, pyridine derivatives, such as copolymers of 2,3,4-vinylpyridine or amine-containing acrylate copolymers, such as 2-dimethylaminoethyl acrylate, 2-diethylaminoethyl acrylate, or 3-dimethylaminopropyl acrylate. Further examples are alkyl or aryl substituted phosphanes, such as e.g. tributylphosphane, triphenylphosphane, tris-p-tolylphosphane, methyldiphenylphosphane, as well as hydroxy and amino functionalized phosphanes. Basic ion exchange resins are also suitable. The catalyst is comprised in components A or B.

It was surprisingly found that bonding agent systems of this type are suitable adhesives/sealants and are distinguished by a very good adhesion to surfaces of the most varied materials. The polyurethane adhesives/sealants are essentially free of NCO groups and can be used alone or as a solution in common organic solvents. The bonding agent basis can vary here and thus for example polyurethanes or polyesters can be comprised as the base polymer. “Essentially free of NCO groups,” means that the NCO content in the components should only represent possible traces from a synthesis reaction.

The inventive bonding agent system is suitable for gluing and sealing the most varied substrates. Exemplary substrates include wood, metal, glass, vegetal fibers, stone, paper, cellulose hydrate, plastics like polystyrene, polyethylene, polypropylene, polyethylene terephthalate, polyvinyl chloride, copolymers of vinyl chloride and vinylidene chloride, copolymers of vinyl acetate olefins, polyamides, particularly plastic films, metals, particularly films of aluminum, lead or copper.

One-component or two-component adhesives, sealants or casting resins can be manufactured from the bonding agent system. These compounds can comprise customary additives, such as plasticizers, silanes, antioxidants, UV stabilizers and anti aging compounds. Preferred plasticizers are esters of phthalic acid, for example dioctyl phthalate, ditridecyl phthalate and butyl benzyl phthalate, esters of phosphoric acid, for example tricresyl phosphate, adipates, for example dioctyl adipates, or benzoates, for example propylene glycol dibenzoate. Amino-, epoxy- or mercaptosilanes, particularly γ-glycidyloxypropyl- or γ-aminopropyl-trimethoxysilane can be added to improve the adhesive strength to glass, metals, etc. The above-cited additives can be comprised in one or both of the components A and B.

In particular, the inventive bonding agent system is suitable as a two-component adhesive for gluing paper, cardboard, wood, plastic, metal or earthenware. In a particularly preferred embodiment of the invention, the inventive bonding agent system is used as a solvent-free or solvent-containing lamination adhesive.

The inventive bonding agent system can be applied to the substrate to be glued with all current application processes, for example by spraying, doctor blades, application roll equipment in the case of the use of a solvent-free bonding agent system or of a solvent-containing bonding agent system.

When a component B4 is added, moisture curable one-component adhesives or sealing compounds can be manufactured. The viscosity of the adhesive can be influenced by the choice of the additives. If high molecular weight polymers are employed as the component A or B, then the viscosity can be reduced for example by solvents, plasticizers or reactive diluents. However, low viscosity adhesive systems can also be manufactured without the use of solvents by using low molecular weight substances as the component A1 or B1. In this case, a viscosity of 100 mPas up to 10,000 mPas, especially between 500 and 5000 mPas is obtained for the 2K adhesive. A higher measurement/application temperature of up to 80° C. is mainly chosen for solvent-free adhesives, a temperature between 20° C. and 30° C. being mainly chosen for measuring solvent-containing adhesives (by Brookfield LVT, EN ISO 2555).

Due to its low viscosity, the inventive adhesive system is particularly suitable for gluing temperature-sensitive plastic films, for example polyolefin films, in particular films of polyethylene or polypropylene.

Accordingly, a further subject matter of the present invention is also a process for the manufacture of composite films that are obtained with the use of the inventive adhesive system by partial or complete surface gluing of at least two identical or different plastic films. Other substrates, e.g. paper or metal films, can optionally be glued with them.

The application of the two-component adhesive onto the films to be glued can be carried out with machinery conventionally used for this purpose, for example with customary lamination machines. For gluing or sealing, at least one side of a substrate to be glued or sealed is coated with the mixture and the side coated in this manner is bonded with at least one additional substrate. Here, the application temperatures can be between 20° C. and 80° C., usually up to 50° C.

A further subject matter of the invention is a composite film, manufactured according to the inventive process by using the inventive adhesive system. The composite film is particularly suitable for packaging foodstuffs and luxury foods and medicinal products.

Inorganic fillers, such as carbon black, calcium carbonate, titanium dioxide and the like are added to the inventive bonding agent system for use as a sealant. Highly dispersed silicas, especially pyrogenic silicas or precipitated silicas, are preferably used as the inorganic fillers due to their thixotropic effect; the thixotropic properties being retained in the inventive bonding agent systems even after longer storage times.

In a further preferred embodiment of the invention, the inventive bonding agent system is used to manufacture insulation foams or casting resins. In particular, the inventive bonding agent system is suitable as a casting resin for electrical building components such as cables, fiber optics, cover strips or plugs to protect them against the ingress of contamination, especially water, as is also needed against mechanical damage during installation or because of temperature exposure. For this, the bonding agent system preferably comprises highly dispersed silica and optionally hollow articles, for example hollow articles of glass as well as preferably a solvent based on hydrocarbons, an organic thickener based on a polymer and optionally a dispersion agent. As a casting resin, the bonding agent system is distinguished by a good thermal stability.

The adhesive or sealing compounds manufactured with the two-component bonding agent system enable systems to be manufactured, which do not comprise any low molecular weight migratable amines. The occupational physiological precautions can be partially relaxed, as neither volatile nor reactive isocyanates are present. The generally high molecular weight amines of the adhesives according to the invention have only a slight tendency to migrate; therefore when films or other plastic substrates are glued, the migration of amines into the packaged goods is reduced even after longer storage times.

Selection of the polymer components enables low viscosity adhesives or casting resins to be manufactured that do not contain any solvent and optionally they can be manufactured without any plasticizer.

In the following, the invention will be described in more detail with some exemplary examples. The given quantities are in percent by weight unless otherwise stated.

### EXAMPLES

Viscosity measurements:

Melt viscosities were measured with an ICI cone plate viscometer from the Epprecht Company, cone type D.
Tensile measurement according to DIN 53504

Raw materials:

| | |
|---|---|
| Polyol A | Liquid polyester polyol with a functionality of 2 with an OH |
| | number of 58 (Henkel) |
| Polyol B | Liquid polyester polyol with a functionality of 2 with an OH |
| | number of 140 (Henkel) |
| Polyol C | Amorphous polyester polyol with an OH number of 43 |
| | (Dynacoll 7150 from Degussa) |
| Polyol D | Crystalline polyester polyol with an OH number of 28 |
| | (Dynacoll 7360 from Degussa) |
| Lupranat MIS | Diphenylmethane diisocyanate, isomeric mixture (BASF) |
| MDI | 4,4′-Diphenylmethane diisocyanate (Desmodur 44 M from |
| | Bayer) |
| PEI | Polyethylenimine, low molecular weight, (Aldrich Chemical |
| | Company) |
| HEA | 2-Hydroxyethyl acrylate |
| Tone M-100 | Caprolactone acrylate (Dow) |
| Desmophen VPLS 2965 | Ketimin (Bayer) |
| Jeffamine T 403 | Trimethylolpropane-poly(oxypropylene)-triamine |
| | (Huntsman) |
| GLYMO | 3-Glycidyloxypropyltrimethoxysilane (Degussa) |
| BHT | 3,5-di-tert.butyl-4-hydroxytoluene |
| TEPA | Tetraethylenepentamine (Bayer) |
| CPP-Film | Cast polypropylene (Nordenia), type PP0946.080 |
| | (thickness 50 μm) |
| PET-Film | Polyethylene terephthalate film type RNK 12 (Mitsubishi) |
| | (thickness 12 μm) |

### Example 1 (Prepolymer)

In a 1 liter four-necked flask equipped with a stirrer, thermometer and an inlet and outlet valve for introducing inert gas were added 120 g polyol A, 100 g polyol B and 80 g polyol C, then melted and dried for 1 hour at 120° C. under a pressure of <10 mbar. After venting with dry nitrogen, the inner temperature was lowered to 90° C. and 82 g MDI were added. The mixture was then further stirred at 100° C. After 1 hour the NCO number was 2.31 wt. %. Then, 0.4 g of BHT were added, homogenized and 24.4 g HEA were added with stirring at a temperature between 100 and 120° C. until the NCO number was less than 0.1 wt. %. The resulting prepolymer had a viscosity of 9000 mPa·s at 125° C.

### Example 2

90 g of the prepolymer from example 1 were dissolved with stirring in 100 g ethyl acetate at room temperature. Then 1.73 g Jeffamine T-403 were added to 50 g of this solution and the mixture was homogenized for 1 minute. This mixture was then coated onto a silicone paper with a doctor blade (gap 500 μm from Erichsen), left to dry in air at room temperature and the melt viscosity was determined from time to time. The melt viscosity (measured at 125° C.) was 15 Pa·s after 5 hours and 189 Pa·s after 24 hours. After 4 days the film had an ultimate tensile strength of 5 N/mm² and an elongation at break of 750%.

### Example 3

90 g of the prepolymer from example 1 were dissolved with stirring in 100 g ethyl acetate at room temperature. Then 0.12 g PEI were added to 25 g of this solution and the mixture was homogenized for 1 minute. This mixture was then coated onto a silicone paper with a doctor blade (gap 500 μm) and left to dry in air at room temperature. After 4 days storage at room temperature, a tensile shear strength of 7 N/mm² was measured and an elongation at break of 360%.

An overlapping adhesion of beech test pieces (Rocholl Company, length×width×thickness 100×25×5 mm, overlap length 10 mm) was carried out with the above-described solution. After 14 days storage at room temperature, a tensile shear strength of 7.1 N/mm² was measured with partial break of the wood.

### Example 4 (Prepolymer)

In a 1 liter four-necked flask equipped with a stirrer, thermometer and an inlet and outlet valve for introducing inert gas were added 120 g polyol A, 70 g polyol B, 80 g polyol C and 80 g polyol D, then melted and dried for 1 hour at 120° C. under a pressure of <10 mbar. After venting with dry nitrogen, the inner temperature was lowered to 90° C. and 58.1 g MDI were added. The mixture was then further stirred at 100° C. After 1 hour the NCO number was 1.80 wt. %. 0.35 g BHT and 17.8 g HEA were then added and stirring was continued until the NCO number was less than 0.1 wt. %. The resulting prepolymer had a viscosity of 32,000 mPa·s at 125° C.

### Example 5

103 g of the prepolymer from example 4 were dissolved with stirring in 100 g ethyl acetate at room temperature. Then 0.13 g PEI were added to 25 g of this solution and the mixture was homogenized for 1 minute. This mixture was then coated onto a silicone paper with a doctor blade (gap 500 μm from Erichsen) and left to dry in air at room temperature. After 14 days the film had an ultimate tensile strength of 11.2 N/mm² and an elongation at break of 205%.

An overlapping adhesion of beech test pieces (Rochol Company, length×width×thickness 100×25×5 mm, overlap length 10 mm) was carried out with the above-described solution. After 14 days storage at room temperature, a tensile shear strength of 1 N/mm² was measured with break of the wood.

### Example 6

104 g of the prepolymer from example 4 were dissolved with stirring in 100 g ethyl acetate at room temperature. Then 0.5 g TEPA were added to 25 g of this solution and the mixture was homogenized for 1 minute. An overlapping adhesion of beech test pieces (Rocholl Company, length×width×thickness 100×25×5 mm, overlap length 10 mm) was carried out with this solution. After 14 days storage at room temperature, a tensile shear strength of 6.4 N/mm² was measured with partial break of the wood.

### Example 7

103 g of the prepolymer from example 4 were dissolved with stirring in 100 g ethyl acetate at room temperature. Then 0.87 g Desmophen VPLS 2965 were added to 25 g of this solution and the mixture was homogenized for 1 minute. An overlapping adhesion of beech test pieces (length×width×thickness 100×25×5 mm, overlap length 10 mm) was carried out with this solution. After 14 days storage at room temperature, a tensile shear strength of 5 N/mm² was measured.

### Example 8

### Prepolymer

In a 1 liter four-necked flask equipped with a stirrer, thermometer and an inlet and outlet valve for introducing inert gas were added 70 g polyol A, 70 g polyol B, 80 g polyol C and 80 g polyol D, then melted and dried for 1 hour at 120° C. under a pressure of <10 mbar. After venting with dry nitrogen, the inner temperature was lowered to 90° C. and 58.1 g MDI were added. The mixture was then further stirred at 100° C. After 1 hour the NCO number was 1.80 wt. %. 0.4 g BHT and 53.5 g Tone-M-100 were then added and stirring was continued until the NCO number was less than 0.1 wt. %. The resulting prepolymer had a viscosity of 20,500 mPa·s at 125° C.

### Example 9

35 g of the polymer from example 8 were dissolved with stirring in 35 g ethyl acetate at room temperature. Then 0.34 g TEPA were added to 20 g of this solution and the mixture was homogenized for 1 minute. The mixture was then coated onto a PET film with a spiral doctor blade (K Hand Coater 620, K-Stab no. 1 from the Erichsen Co.) and the solvent was volatilized by careful blowing. Immediately afterwards, a sheet of CPP film whose surface had been corona treated, was applied and forcefully pressed on evenly and free of bubbles with a press roller (Henkel) and stored at room temperature. Strips of 15 mm width were then cut out of this composite film and the adhesive strength of the composite was determined with a 90° C. peel test on a tensile testing machine (Instron 4301). The test speed was 100 mm/min. After 1 day storage at room temperature, a value of 5 N/15 mm was measured.

### Example 10

35 g of the prepolymer from example 8 were dissolved with stirring in 35 g ethyl acetate at room temperature. Then 0.1 g PEI were added to 20 g of this solution and the mixture was homogenized for 1 minute. The mixture was then coated onto a PET film with a spiral doctor blade (Erichsen Co.) and the solvent was volatilized by careful blowing (ca. 3 min.). Immediately afterwards, a sheet of CPP film whose surface had been corona treated, was applied and forcefully pressed on evenly and free of bubbles with a press roller and stored at room temperature. Strips of 15 mm width were then cut out of this composite film and the adhesive strength of the composite was determined with a 90° C. peel test on a tensile testing machine (Instron 4301). The test speed was 100 mm/min. After 1 day's storage at room temperature, a value of 10 N/15 mm was measured and a tear in the PET film was observed.

### Example 11

35 g of the prepolymer from example 8 were dissolved with stirring in 35 g ethyl acetate at room temperature. Then 0.1 g PEI were added to 20 g of this solution and the mixture was homogenized for 1 minute. This mixture was then coated onto the aluminum side of an aluminum/PET composite film (aluminum foil, 12 μm thick from Norsk Hydro; PET-film, 12 μm thick, type RNK 12 from Mitsubishi, laminated with Liofol UK 3640/6800 from Henkel) with a spiral coating blade (Erichsen Company) and the solvent was evaporated away by carefully blowing warm air. Immediately afterwards, a sheet of CPP film whose surface had been corona treated, was applied and forcefully pressed on evenly and free of bubbles with a press roller and stored at room temperature. Strips of 15 mm width were then cut out of this composite film and the adhesive strength of the composite of polypropylene against aluminum was determined with a 90° C. peel test on a tensile testing machine (Instron 4301). The test speed was 100 mm/min. After 1 day storage at room temperature, a value of 6 N/15 mm mm was measured and after 7 days 8 N/15 mm.

### Example 12

To a solution according to example 11 was additionally added 1 wt. % GLYMO, based on the solids. This mixture was then coated onto the aluminum side of an aluminum/PET composite film (aluminum foil, 12 μm thick from Norsk Hydro; PET-film, 12 μm thick, type RNK 12 from Mitsubishi, laminated with Liofol UK 3640/6800 from Henkel) with a spiral coating blade (Erichsen Company) and the solvent was evaporated away by blowing warm air for 3 minutes. Immediately afterwards, a sheet of CPP film whose surface had been corona treated, was applied and forcefully pressed on evenly and free of bubbles with a press roller and stored at room temperature. Strips of 15 mm width were then cut out of this composite film and the adhesive strength of the composite of polypropylene against aluminum was determined with a 90° C. peel test on a tensile testing machine (Instron 4301). The test speed was 100 mm/min. After a 7 day storage at room temperature, a value of 11 N/15 mm was measured.

1. A two-component bonding agent system comprising:
(a) a component A comprising at least one polymer having
i) at least two Michael acceptor groups and
ii) a number average molecular weight (Mₙ) of from 1,000 g/mol to 1,000,000 g/mol;
(b) a component B comprising at least one polymer or oligomer having at least two amino groups, wherein the amino groups are primary, secondary or blocked amino groups; and
(c) optionally an additive, auxiliary and/or catalyst.

2. The two-component bonding agent system according to claim 1, wherein the Michael acceptor groups are located terminally on the polymer in the component A.

3. The two-component bonding agent system according to claim 1, wherein the Michael acceptor groups are statistically distributed over the polymer in the component A.

4. The two-component bonding agent system according to claim 1, wherein the polymer in component A has side chains and the Michael acceptor groups are located on said side chains.

5. The two-component bonding agent system according to claim 1, wherein the Michael acceptor groups in the component A are α,β-unsaturated keto groups or ester groups.

6. The two-component bonding agent system according to claim 5, wherein the Michael acceptor groups in the component A are C₃ to C₁₂ mono- or di-carboxylic acid ester groups.

7. The two-component bonding agent system according to claim 1, wherein the polymer in the component A has a molecular weight of from 1,500 to 100,000 g/mole.

8. The two-component bonding agent system according to claim 1, wherein the amino groups of the polymer or oligomer in the component B are terminal primary amino groups.

9. The two-component bonding agent system according to claim 1, wherein the amino groups of the polymer or oligomer in the component B are blocked amino groups.

10. The two-component bonding agent system according to claim 1, wherein the polymer or oligomer in the component B is at least a two-functionally substituted polyether amine.

11. The two-component bonding agent system according to claim 1, wherein the molecular weight of the polymer or oligomer in the component B is from 60 to 2,000,000 g/mol.

12. The two-component bonding agent system according to claim 1, wherein the component B comprises a mixture of:
(a) a component B1 which is a alkylenediamine and/or cycloalkylenediamine; and
(b) a component B2 which is an amino functionalized polyalkylene glycol.

13. The two-component bonding agent system according to claim 12, wherein the component B further comprises a component B3 which has at least one primary amino group and a molecular weight of from 50 to 5,000 g/mol.

14. The two-component bonding agent system according to claim 1, wherein the ratio of the Michael acceptor group in the component A to the amino groups in the polymer or oligomer in the component B is between 3:1 to 1:5.

15. The two-component bonding agent system according to claim 14, wherein the ratio of the Michael acceptor group in the component A to the amino groups in the polymer or oligomer in the component B is between 2:1 to 1:2.5.

16. The two-component bonding agent system according to claim 1, wherein the catalyst is a Lewis or Brönstedt base with a pKa value of conjugated acid greater than 10, and said catalyst comprises up to 5 wt % of the total system.

17. The two-component bonding agent system according to claim 1, wherein the component A further comprises polyunsaturated carboxylic acid esters with molecular weights below 500 g/mole.

18. An article comprising the two-component bonding agent system of claim 1.

19. The article of claim 18 which is a composite film.
